(19) United States
(12) Patent Application Publication
(10) Pub. No.: US 2016/0158900 A1
(43) Pub. Date: Jun. 9, 2016

(54) Vortex Tube

(71) Applicant: Universal Vortex Inc., Hamilton, NJ (US)

(72) Inventor: Lev Tunkel, Princeton, NJ (US)

(73) Assignee: Universal Vortex Inc.

(21) Appl. No.: 14/559,334

(22) Filed: Dec. 3, 2014

(51) Int. Cl. B23P 15/26; F25B 9/04

(52) U.S. Cl. CPC B23P 15/26; F25B 9/04

(57) ABSTRACT

A vortex tube is disclosed. A vortex tube is a slender tube with a diaphragm closing one end of the tube with a discharge hole in the center of the diaphragm with tangential inlet nozzles. The vortex tube separates an inlet gas stream into two compartments. The present invention relates to an optional geometry of the vortex tube for use with compressed natural gas.

### BACKGROUND OF THE INVENTION

1. Field of the Invention

This invention is directed to the field of vortex tubes. More particularly, the present invention relates to a manufacture using a method of a vortex tube design, which provides a vortex tube having a high efficiency by eliminating freeze up in operations with natural gas.

2. Description of the Prior Art

A vortex tube (VT) comprises a slender tube with a diaphragm with a discharge hole in the center of the diaphragm, closing one end of the tube, one or more tangential inlet nozzles piercing the tube just inside of the diaphragm and, depending on the vortex tube's desirable performance, a controlled discharge opening (throttle valve) or plug (U.S. Pat. No. 5,911,740) on the other end of the slender tube.

In the vortex tube, the inlet high-pressure gas passes through the tangential nozzles resulting in a pressure decrease and velocity increase of the gas. The low pressure highly rotating gas then undergoes energy separation (vortex phenomenon) forming two internal low-pressure currents. One current is cold and the other is hot. Under some circumstances a cold fraction or cold gas discharged from the vortex tube through the diaphragm opening may freeze up and reduce the diameter of the discharge orifice due to the formation of ice, resulting in the vortex tube's performance deterioration.

It is known to use a vortex tube's hot fraction to prevent freezing in the discharge diaphragm (U.S. Pat. No. 5,749,231 and U.S. Pat. No. 5,937,654) as well as, as it is practiced in the vortex tubes of the present invention to use the hot fraction to warm up the vortex tube's inlet nozzles.

### SUMMARY OF THE INVENTION

The present invention provides for improving the reliability of the vortex tubes designed per U.S. Pat. Nos. 5,749,231 and 5,937,654 in operation with compressed natural gas. The improvement is achieved by specifying the VT diaphragm hole preferably in a range of 0.25 to 0.80 of the slender tube's diameter, the vortex tube's length, preferably, as no less than 3 diameters of the slender tube and the vortex tube's uncontrolled opening diameter as no greater than 0.60 of the slender tube's diameter.

### BRIEF DESCRIPTION OF THE DRAWINGS

FIG. 1 is a schematic design and flow diagram of an embodiment of the invention

### DETAILED DESCRIPTION OF THE PRESENT INVENTION

The present invention will now be described in terms of the presently preferred embodiment thereof as illustrated in the drawings. Those of ordinary skill in the art will recognize that this embodiment is merely exemplary of the present invention and many obvious modifications may be made thereto without departing from the spirit or scope of the present invention as set forth in the appended claims.

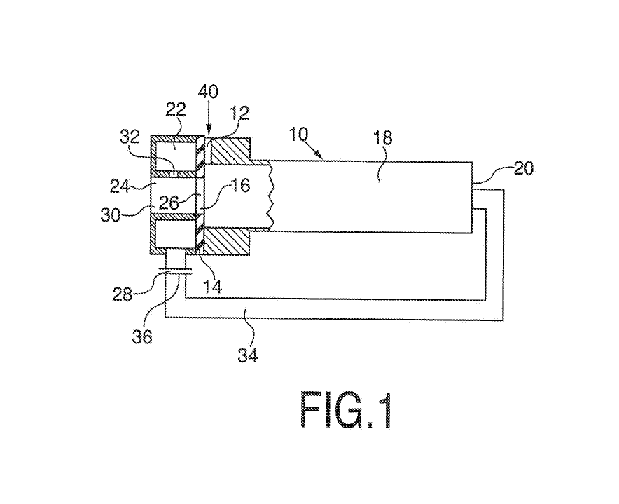

The flow diagram in FIG. 1 illustrates an embodiment of the invention. A non-freeze vortex tube assembly 50 according to the invention includes a vortex tube 10 provided with the inlet nozzle 12, a diaphragm 14 provided with a central hole 16, a slender tube 18 of the internal diameter D with its outlet opening 20 and a heat exchanger 22 provided with an inner passage 24, two inlet openings 26 and 28, one outlet opening 30 and an uncontrolled opening 32 set up on the inner passage's 24 surface. Openings 26 and 30 also serve as inner passage's 24 inlet and outlet, respectively. A gas flow in the direction of arrow 40 enters assembly 50 through the vortex tube's nozzles 12 and then undergoes an energy (temperature) separation forming a cold and hot fraction. A cold fraction is discharged from the vortex tube 10 through diaphragm hole 16 and enters into a heat exchanger inlet opening 26, then goes through inner passage 24 in the heat exchanger and leaves or exits the heat exchanger 22 through its outlet opening 30. A hot fraction passes through slender tube's 18 outlet opening 20 and is then directed through line 34 and its outlet 36 and enters into heat exchanger 22 through inlet opening 28 and goes toward the uncontrolled opening 32 simultaneously flowing over the surfaces on the inside of the heat exchanger 22 and leaves or exits the heat exchanger through uncontrolled opening 32, mixing up with the cold fraction exiting the vortex tube. The uncontrolled opening is preferably located on such side of the passage 30 which is opposite to the heat exchanger inlet 28; the opening diameter is, preferably, less than vortex tube's diaphragm diameter.

It is known that a small portion of the vortex tube's inlet gas flow doesn't participate in the vortex energy division but moves alongside the diaphragm inward surface directly into the diaphragm hole. The existence of such a bypass flow is due to the presence of the radial pressure gradient uncompensated by the centrifugal forces in the stationary boundary layer on the wall of the diaphragm. Mixture of the bypass flow that keeps the original inlet gas temperature with the cold gas passing through the diaphragm hole increases the vortex cold outlet temperature. Such thermal influence, at times noticeable, doesn't affect the vortex tube operations unless compressed natural gas is used as the vortex tube's working medium.

Here the gas passing through the VT's pressure reducing nozzles, generally, carries some liquid (water and hydrocarbons) condensed under the depressurized gas low thermodynamic temperatures and Joule-Thomson temperature drop. The condensed liquid, due to its gravity, provides for a substantial portion of the by-pass flow. The two-phase chilled mixture mixing up with the vortex tube's cold outlet or with the vortex tube's single discharge flow (per U.S. Pat. No. 5,911,740) results in freezing of the diaphragm hole which reduces the interior diameter of the orifice 16 and accordingly the vortex tube performance deteriorates.

Reduction of the diaphragm's hole 16 diameter is an efficient way to reduce the by-pass stream flow rate. However, a smaller diaphragm hole increases the gas pressure in the vortex tube. This results in decreasing the vortex pressure ratio (ratio of the inlet gas pressure to the gas pressure in the vortex tube). This, in turn, reduces the intensity of the vortex energy division in the gas flow. The best results with the present invention can be achieved by specifying the diaphragm's hole diameter 16, preferably, in a range of 0.25 to 0.80 of the slender tube diameter D. The length of the vortex tube shall allow for completing the vortex energy division, thus to efficiently warm the diaphragm in a heat exchanger as described U.S. Pat. No. 6,289,679. The uncontrolled opening 32 in a heat exchanger shall allow for efficient circulation of just the vortex hot (peripheral) flow without blending it with the vortex cold (central) flows. The optimal results with the present invention can be achieved by specifying the length of the vortex tube as no less than 3.0 diameters (D) of the slender tube and the uncontrolled opening's diameter as no greater than 0.60 diameter (D) of the slender tube.

What is claimed is

1. A method for a non-freeze enhancement in a vortex tube assembly, said non-freeze enhanced vortex tube assembly includes a heat exchanger having an uncontrolled opening in its inner passage and a vortex tube comprising a slender tube with a diameter (D), a diaphragm having a hole in the center thereof and closing one end of the vortex tube, one or more tangential nozzles piercing the slender tube just inside the diaphragm and an outlet opening on the other end of the vortex tube, the method comprises ways of connecting the non-freeze enhanced vortex tube as follows:
a. attaching a heat exchanger to an outward side of a vortex tube's diaphragm;
b. connecting a vortex tube's diaphragm hole for discharging a cold fraction flow with a heat exchanger's inlet opening and then connecting the inlet opening through a heat exchanger's inner passage with a heat exchanger's outlet opening to discharge gas flow from the non-freeze enhanced vortex tube assembly; and
c. connecting a vortex tube outlet opening at the far end of the vortex tube with another heat exchanger's inlet opening, thus providing for the hot flow to flow over the surfaces on the inside of the heat exchanger and then leave or exit the heat exchanger through an uncontrolled opening in the heat exchanger's inner passage to mix with the cold fraction exiting the vortex tube.

2. The method of claim 1 wherein the uncontrolled opening diameter is no greater than 0.6 times the slender tube diameter (D).

3. The method of claim 1 wherein the vortex tube diaphragm hole has a diameter in the range of 0.25 to 0.80 times the slender tube diameter (D).

4. The method of claim 1 wherein the length of the vortex tube is no less than 3 times the slender tube diameter (D).
